(19) United States
(12) Patent Application Publication
(10) Pub. No.: US 2026/0264658 A1
(43) Pub. Date: Sep. 10, 2026

(54) STEERING SYSTEM FOR A MOTOR VEHICLE

(71) Applicants: thyssenkrupp Presta AG, Eschen (LI); thyssenkrupp AG, Essen (DE)

(72) Inventors: Tamas UNGVARI, Budapest (HU); Csaba ARANYI, Diósd (HU); Dávid POKOL, Záhony (HU)

(73) Assignees: thyssenkrupp Presta AG, Eschen (LI); thyssenkrupp AG, Essen (DE)

(21) Appl. No.: 19/165,955

(22) PCT Filed: Oct. 24, 2023
(86) PCT No.: PCT/EP2023/079637

§ 371 Date: Sep. 16, 2025

(30) Foreign Application Priority Data
Mar. 17, 2023 (BE) BE 2023/5196

(51) Int. Cl. B60T 13/74; H02K 1/16; H02K 1/274

(52) U.S. Cl. CPC B60T 13/746; B60T 13/741; H02K 1/165; H02K 1/274; H02K 2201/03; H02K 2213/03

(57) ABSTRACT

An electromechanical braking device for a motor vehicle comprises an actuating device which is driveable by at least one electric motor and by which a brake part is adjustable, wherein the motor has a stator and a rotor, which is rotatably mounted therein about a motor axis, wherein the rotor comprises rotor magnets which are distributed over the outer circumference, are in the form of permanent magnets and extend in a rod-shaped manner axially parallel to the rotor axis, and which each have a radial magnet thickness and a magnet width in the circumferential direction. A ratio of the magnet thickness to the magnet width is between 0.4 and 0.55.

### PRIOR ART

The invention relates to an electromechanical braking device for a motor vehicle, comprising an actuating device which is driveable by at least one electric motor and by which a brake part is adjustable, wherein the motor has a stator and a rotor, which is rotatably mounted therein about a motor axis, wherein the stator has a stator outer diameter and a stator inner diameter and comprises a number of radially inwardly projecting stator teeth which are distributed over the circumference, have a tooth width in the circumferential direction on the stator outer diameter and between which a stator gap having a gap width is in each case located on the stator inner diameter, and which support at least one stator winding, wherein the rotor comprises a rotor diameter and a number of poles, which deviate from the number of stator teeth, of rotor magnets which are distributed over the outer circumference, are in the form of permanent magnets and extend in a rod-shaped manner axially parallel to the rotor axis, and which each have a radial magnet thickness and a magnet width in the circumferential direction, and the rotor magnets are each spaced apart at a magnet distance on the rotor diameter, wherein a radial air gap having a radial air gap width is formed between the stator teeth and the rotor magnets.

Such a braking device of a motor vehicle is designed as a friction brake, in which a brake part which is supported on the chassis and is fixed relative to the rotation of the wheel to be braked can be brought by means of an actuating device into braking engagement with a counter-brake part, which rotates with the wheel. During the braking engagement, friction contact is produced between the brake part and the counter-brake part, with the braking torque produced by friction being greater, the higher the adjustment force is which is exerted by the actuating device in the adjustment direction.

The disk brakes which are known in principle and in which the counter-brake part is formed by a brake disk, which rotates with the wheel and is axially surrounded on both sides by a brake caliper, are widespread. By means of at least one preferably linear actuating drive, which is axially supported on the brake caliper, a brake part, usually a brake pad, can be adjusted in an axial adjustment direction and thereby brought into friction contact with an axial side of the brake disk, wherein, during the braking engagement, the brake disk is frictionally clamped between the adjusted brake part and a further brake part, which is supported axially opposite the brake caliper.

It is known from DE 10 2017 123 266 A1 that the actuating drive has two actuating drives arranged in series in the adjustment direction. Each of the actuating drives has a drive-side drive element and an output-side output element, which is linearly adjustable relative thereto in the axial adjustment direction. For the realization of an adjustment movement, each drive element has a drive wheel, preferably a transmission wheel, such as a gearwheel or the like, which is rotationally driveable about its axis by an electric motor, the actuating motor. The rotation of the drive wheel is converted in the actuating drive in each case into a relative adjustment movement or an actuating stroke of the output element relative to the drive element in the axial adjustment direction. In the prior art in question, the two drive wheels of the first and second actuating drive are arranged coaxially on a common axis lying in the axial adjustment direction.

An actuating drive in each case forms a lifting or adjusting device that is axially effective in the adjustment direction. For example, an actuating drive may have a spindle drive, in which the drive element has a spindle nut and the output element a threaded spindle engaging therein, or vice versa. It is also possible to use other designs of actuating drives which may comprise, for example, ramp bearings, cam disks, tilting pin arrangements or the like, and likewise convert rotation of the drive element into a linear adjustment of the output element.

For the drive of an actuating drive, a motor in the form of an internal permanent magnet synchronous motor is in each case provided. The latter has a stator with stator windings which are wound on a plurality of stator teeth which are distributed over the circumference and are directed radially inward onto the motor axis. The number of stator teeth corresponds to a multiple of the phase number of the motor current. The rotor, which is rotatably mounted about the motor axis, has, distributed over its outer circumference, a number of permanent magnets corresponding to the number of poles, which permanent magnets form the rotor magnets and lie radially on the inside opposite the stator teeth at the spacing of the circumferential air gap.

In the case of the braking device of the type in question, high operational safety and efficiency with the lowest possible weight and installation space requirement of the motor(s) are essential. The motors known in the prior art have disadvantages in this respect.

In view of the problem explained above, it is an object of the present invention to make possible an efficient drive and a compact design of a braking device of the type in question.

### SUMMARY OF THE INVENTION

This object is achieved according to the invention by the steering system having the features of claim 1. Advantageous developments emerge from the dependent claims.

In the case of an electromechanical braking device for a motor vehicle, comprising an actuating device which is driveable by at least one electric motor and by which a brake part is adjustable, wherein the motor has a stator and a rotor, which is rotatably mounted therein about a motor axis, wherein the stator has a stator outer diameter and a stator inner diameter and comprises a number of radially inwardly projecting stator teeth which are distributed over the circumference, have a tooth width in the circumferential direction on the stator outer diameter and between which a stator gap having a gap width is in each case located on the stator inner diameter, and which support at least one stator winding, wherein the rotor comprises a rotor diameter and a number of poles, which deviate from the number of stator teeth, of rotor magnets which are distributed over the outer circumference, are in the form of permanent magnets and extend in a rod-shaped manner axially parallel to the rotor axis, and which each have a radial magnet thickness and a magnet width in the circumferential direction, and the rotor magnets are each spaced apart at a magnet distance on the rotor diameter, wherein a radial air gap having a radial air gap width is formed between the stator teeth and the rotor magnets, it is provided according to the invention that the ratio of the magnet thickness to the magnet width is between 0.4 and 0.55.

The radial inner sides of the stator teeth delimit a cylindrical stator inner diameter. The internal cross section of the stator teeth is correspondingly cylindrical in cross section.

The tooth width corresponds to the tooth root width, measured in a circumferential direction, in a radially outer external region of a stator tooth facing away from the air gap. There, the stator teeth can be connected to a preferably hollow-cylindrical stator body, which is continuous or segmented in the circumferential direction.

In their end region which lies radially on the inside and faces the air gap, adjacent stator teeth are spaced apart at a stator gap, which has a gap width measured in the circumferential direction.

The rotor magnets are attached to the outer side of the rotor in such a way that their outer surfaces lie radially opposite the inner surfaces of the stator teeth at the spacing of the air gap width.

The rod-shaped rotor magnets have a solid profile which is elongate in the axial direction parallel to the motor axis. They preferably have a continuous cross section and are preferably formed from a hard-magnetic magnet material with a high coercive field strength, for example SmCo, NdFeB alloys or the like.

According to the invention, a dimensional ratio in the radial direction and in the circumferential direction is defined for the cross section of the magnetic material. It has been found that an optimized distribution of the magnetic field is achievable as a result, with the dimensions and the weight of the rotor advantageously being able to be reduced. This results in the advantage that a relatively high motor torque can be realized with a relatively small rotor diameter. Accordingly, the stator inner diameter and thus the overall dimensions and the weight of the stator can also be reduced, thus enabling a powerful, lightweight and compact design of the braking device.

The advantageous reduction in installation space and weight can be particularly high in the design of a braking device which has at least two motors. Preferably, each of the motors is designed according to the invention.

It may be provided that the rotor magnets have a rectangular cross section. The solid profile of the rotor magnet, which is continuously rectangular in cross section over the axial length, has, radially on the outside, an outer surface which lies tangentially to a circumferential direction, i.e., is perpendicular to the diameter, and an inner surface which lies radially on the inside parallel thereto, and side surfaces that are parallel to each other and parallel to the diameter of the rotor. The outer surface, the inner surface and the side surfaces can preferably be substantially flat. Such rotor magnets can be provided cost-effectively in an advantageous manner with optimized magnetic properties and integrated in the rotor.

Alternatively, it can be provided that the rotor magnets have a cross section in the shape of a hollow cylinder segment. The rotor magnet, which is in the shape of a hollow cylinder segment in cross section, has a cylindrical outer surface which is coaxial to the rotor axis and the diameter of which corresponds to the rotor diameter, and a cylindrical inner surface which is coaxial thereto and the diameter of which corresponds to the rotor diameter minus the magnet thickness. The flat side surfaces delimiting the rotor magnet in the circumferential direction are parallel to each other and parallel to the diameter of the rotor. The cylindrical outer surface preferably has a cylinder diameter which corresponds to the inner diameter of the stator minus the air gap width. The advantage here is that the air gap width can be constant over the entire circumference of the rotor, which allows an optimized magnetic flux to be realized.

As an alternative to the two abovementioned embodiments, it is possible for the rotor magnets to have a segment-like cross section with a cylindrical outer surface and a flat inner surface. The rotor magnet has a cylindrical outer surface which is coaxial to the rotor axis and the diameter of which corresponds to the rotor diameter, and a substantially flat inner surface which lies tangentially to a circumferential direction, i.e., is perpendicular to the diameter. The advantage is that the air gap width can be constantly predetermined over the entire circumference, with it being possible for a relatively high magnetic flux to be realized.

One advantageous embodiment is that a rotor magnet extends on the rotor diameter with respect to the motor axis over a magnetic angle section, and the rotor magnets are offset relative to one another by a pole angle, the ratio of the magnetic angle section to the pole angle being between 0.65 and 0.75. This allows an optimized magnet distance between the rotor magnets in the circumferential direction to be realized, which is advantageous for a compact design.

It is preferably possible for the number of poles to be 8 or 10. The number of poles is determined by the number of rotor magnets distributed over the circumference. A high number of poles allows the motor torque to be evened out and the smoothness to be improved, albeit with a high outlay on production. Conversely, a small number of poles can be achieved with less effort, but with less smoothness and a more uneven motor torque. It has been found that the number of poles according to the invention is optimal for use in the braking device.

It is advantageous that the number of stator teeth is 6 or 9. The number of stator teeth is a multiple of the number of phases of the current for powering the motor. For use in a braking device, a combination of 6 stator teeth with 8 rotor magnets is advantageous, and a combination of 9 stator teeth with 10 rotor magnets is particularly advantageous.

It is preferably provided that the ratio of the air gap to the tooth width is between 0.45 and 0.65. Particularly preferably, the ratio of the air gap width to the tooth width is between 0.5 and 0.6. This enables an optimized magnetic flux to be realized, which permits a high motor torque and great smoothness with compact dimensions and low weight.

It is advantageous that the ratio between the stator outer diameter and the stator inner diameter is between 0.55 and 0.65. This enables optimized magnetic properties to be realized in a compact design.

An advantageous embodiment can provide for the ratio between the air gap width and the stator inner diameter to be between 0.015 and 0.03. This ratio is advantageous in terms of high efficiency and a compact design.

The invention further comprises an electromechanical braking device for a motor vehicle, comprising a drive carrier, to which an electric motor and an actuating device is attached, the actuating device being coupled in terms of gearing to a motor shaft and being usable to adjust a brake part, wherein the motor has a motor housing, in which the motor shaft which is extended in the axial direction is mounted in an end-face bearing cover and protrudes axially therefrom, wherein the motor housing is fixed to the drive carrier. It can preferably be provided that the drive carrier has a recess in which the motor housing can be received in a form-fitting manner in the axial and radial direction, wherein the motor housing can be clamped on the end face against an axial support surface of the recess.

The recess provides a receptacle for the motor, in which the motor housing can be received in a defined manner aligned axially and radially in a defined manner relative to the drive carrier. The recess has an opening which is continuous through the drive carrier and through which the motor shaft is passed perpendicularly through the drive carrier.

The support surface can be formed on a support projection which projects radially inward into the opening of the recess, for example on a step or the like arranged at the edge of the opening. The open cross section of the recess is matched to the outer cross section of the motor housing in such a way that it can be introduced with little radial play axially—forward by definition in the direction of the motor axis defined by the motor shaft—into the recess until it strikes axially against the support surface. The motor shaft protrudes on the side of the drive carrier facing away from the motor.

The bearing cover located on the front end face of the motor housing can be supported against the support surface and clamped to the motor housing.

One advantage is that the motor housing, when inserted in the recess, is held in a form-fitting manner in the radial direction and, when it strikes against the support surface, is also supported in a form-fitting manner in the axial direction. Thus, the motor received in the recess is positioned in a spatially defined manner relative to the drive carrier. Clamping to fix the motor in place can occur after it is inserted into the recess. The installation is thereby advantageously simplified and a defined meshing with the actuating device can be provided in a simple way, for example via intermeshing gearwheels of the motor shaft and the actuating device.

It is possible for the support surface to be formed on a projection projecting radially inward in the recess. The projection can preferably have a step or the like which runs around the inside of the recess at least over part of the circumference and on which the support surface is formed parallel to the planar extent of an installation portion of the drive carrier.

It is preferable for the bearing cover to be attached to the end face of the motor housing. The bearing cover can be provided initially as a separate part and, during the assembly, joined together with the motor housing after the rotor has been inserted with the motor shaft. This enables the motor to be installed efficiently.

It can be provided that the bearing cover is supported axially against the support surface.

The bearing cover which is attached axially to the front of the motor housing can lie with its front end face, which faces away from the motor housing, against the support surface. On its rear side facing axially away from the end face, the bearing cover is connected to the motor housing.

It is advantageous that the bearing cover can be clamped between the support surface and the motor housing. The bearing cover has at least one section which is arranged axially between the motor housing and the support surface. Thus, the bearing cover can be clamped axially against the motor housing by the fact that the latter is clamped against the support surface. In other words, the bearing cover is located at least in sections in the force flux of the clamping of the motor housing to the drive carrier. During the clamping, this enables the motor to be fixed to the drive carrier and the bearing cover to be fixed to the motor housing in one single installation step, and therefore the outlay is advantageously reduced.

For example, the bearing cover can have an axial shoulder which is inserted into an axial opening in the motor housing, and a circumferential collar which projects radially outward over the cross section of the opening. The collar can have substantially the same outer cross section as the motor housing, and is axially positioned between the support surface and the motor housing. When the motor housing is clamped against the support surface, the bearing cover can thereby be supported on the support surface at the same time and secured on the motor housing. One advantage here is that the bearing cover merely has to be provisionally connected to the motor housing before the motor is installed in the brake device, and the final fixing can be carried out in one installation step when the motor is clamped to the drive carrier. The clamping thus fulfills a dual function of fixing the motor to the drive carrier and fixing the bearing cover on the motor housing. For example, the bearing cover can be inserted with an axial shoulder simply in a force-fitting manner into the motor housing or plugged onto the motor housing. This can eliminate the need for costly screw connections, welding connections or other joining connections between the bearing cover and the motor housing, thus simplifying the design of the motor, and enabling weight to be saved.

It can preferably be provided that the motor housing has a flange element which is axially spaced apart from the end face and protrudes radially over the recess.

The flange element protrudes radially outward from the motor housing and protrudes over the recess. It is connectable to the drive carrier. For this purpose, fastening means can be provided, which can be connected outside the recess to the drive carrier in order to clamp the motor housing axially against an outer side of the brake housing. For example, in the flange element, preferably a plurality of axial flange bores can be distributed over the circumference, through which fastening elements, such as screws or the like, can be guided and can be screwed into corresponding threaded bores in the drive carrier. As a result of the fact that the flange element is at an axial distance from the front end face of the bearing cover, the axial clamping of the flange element against the drive carrier can cause the motor housing entering the recess to be clamped with the bearing cover on the end face against the support surface arranged in the recess. In this way, by means of the flange element, the motor can be fixed to the drive carrier in the position defined by the recess, and, at the same time, the bearing cover can thereby be clamped and fixedly connected to the motor housing.

The axial distance of the flange element from the end face of the bearing cover attached on the end face to the front of the motor housing is preferably greater than the depth of the recess, measured from the support surface to the outer side of the drive carrier in the region of the flange element. As a result, by means of clamping of the flange element, the bearing cover can be clamped axially between the support surface and the motor housing. The advantage is that the bearing cover can be securely connected to the motor housing without additional connecting means by the connection of the motor housing to the drive housing. This enables the motor to be simpler and lighter.

It can be provided that the motor housing at least partially has a hollow cross section to which the bearing cover can be secured in a form-fitting manner. The motor housing can, for example, be in the form of a pot or cup and can be axially closed at the front by the bearing cover attached thereto. The motor shaft having the rotor can be mounted in one end region on the inside of the motor housing and, with its other end region, can be rotatably mounted in the bearing cover and guided outward through the latter. The hollow cross section can, for example, have a substantially cylindrical tubular section, from the open end face of which the bearing cover can be secured by axial clamping. For example, a cylindrical shoulder of the bearing cover can be inserted in a form-fitting manner into the opening of the hollow cross section, and a substantially annular collar can be clamped in the manner described above between the support surface and the end face of the tubular section.

It may be advantageous for the motor housing, the bearing cover and/or the drive carrier to have a cast part. The cast part may be an injection-molded part made of a thermoplastic, which may optionally be fiber-reinforced to increase the strength, or a diecast part made of a metallic material, for example of aluminum, magnesium or zinc alloys. In the casting process, complex shapes can be efficiently realized. For example, the recess according to the invention and optionally other functional elements can be molded integrally on the drive carrier. Correspondingly, the flange element and optionally other functional elements can be molded integrally on the motor housing. For example, a shoulder for connecting to the motor housing, and a bearing receptacle for the motor shaft or the like can be molded integrally on the bearing cover.

It is possible for an elastic holding element and/or sealing element to be arranged between the recess and the motor housing. For example, an elastically deformable O-ring made of a rubber or polymer material can be radially clamped between a circumferential inner surface of the recess and an outer surface of the motor housing. As a result, the motor housing can already be provisionally held in position by simple insertion axially into the recess on the drive carrier in a force-fitting or frictional manner, as a result of which the subsequent clamping can be simplified. It can be advantageously provided that an O-ring is received in a circumferential groove of the recess or the motor housing and thus held in a form-fitting manner in the axial direction.

In addition, an O-ring or another elastic sealing element can effectively seal the motor housing in the recess against the penetration of moisture or contaminants.

Preferably, it can be provided that the drive carrier has at least two recesses. A motor which can in each case drive an actuating drive of the actuating device can be fixed in each of the recesses. This makes it possible to mount two motors for driving two actuating drives of the actuating device on the drive carrier. It is advantageous that, according to the invention, both motors can be simply and securely positioned and mounted relative to the actuating drives.

One advantageous embodiment can provide that the braking device comprises an actuating device and a brake part which is connected thereto, is adjustable along an axis by the actuating device and can be brought into braking engagement with a counter-brake part, wherein the actuating device has a first actuating drive and a second actuating drive which is coupled in series thereto, wherein the first actuating drive has a rotationally driveable first drive wheel, and the second actuating drive has a rotationally driveable second drive wheel which is coaxial with the first drive wheel, wherein a clutch device is arranged between the first drive wheel and the second drive wheel.

The actuating device is driveable by at least one electric actuating motor. The latter preferably meshes with at least one drive wheel. Preferably, one actuating motor can in each case be provided for the first and second drive wheel. According to the invention, the actuating motor or the actuating motors are activatable by a wheel brake control unit assigned to the braking device.

It can be provided that the clutch device is configured as a friction clutch having a friction element which, during engagement of the clutch, is connectable in a frictional manner to a counter-friction element.

In the following text, the first and the second drive wheel together are also referred to as the two drive wheels or as the drive wheels for short.

The drive wheels can each be designed as a gearwheel, for example as a spur gear, or as a belt wheel or timing belt pulley or worm wheel, and therefore generally a transmission wheel by way of which a driving torque from an electric actuating motor can be coupled into the actuating drive is provided.

A friction clutch is implemented between the drive wheels. Said friction clutch comprises a friction element, which is connected torque-lockingly to one of the drive wheels, and a corresponding counter-friction element, which is connected torque-lockingly to the respective other drive wheel. The friction element can be brought into frictional coupling engagement with the counter-friction element in any relative angular position. As opposed to a form-fitting latching connection, a purely force-fitting clutch is implemented here. As a result, the relative position of the drive wheels with respect to one another can be predefined continuously, in contrast to the discrete latching stages of a latching connection. Accordingly, a uniform, continuous adjustment of the second actuating drive relative to the first actuating drive is possible, and the air gap can be continuously adjusted. This is particularly advantageous with regard to uniform tracking of the optimum working point of the braking device to the continuous wear of the brake part during operation, i.e. the continuous wear of the brake pad. Compared to an only gradual adjustment option, a continuously improved response behavior of the braking device, and thus increased operational reliability and greater operating comfort, can be implemented.

Another advantage in comparison to a latching clutch resides in the fact that, for actuating and releasing the clutch device, essentially no axial relative movement is required between the clutch elements which are in clutch engagement, for example between the drive wheels or the latching elements, which inevitably have to be movable relative to one another in order to produce and release the latchable form fit. On the other hand, the pure force fit between the friction element and counter-friction element according to the invention can be simply predetermined by the applied axial actuation force, wherein the friction element and counter-friction element do not have to be moved axially relative to each other. This enables a simpler and more reliable structural design of the clutch device.

It is preferably provided that the friction clutch has a predefinable clutch torque. The clutch torque specifies the maximum differential torque, which can be transmitted with a force fit between the friction element and the counter-friction element by the friction connection during the engagement of the clutch. When the clutch torque is exceeded, the clutch device slips such that the two drive wheels are rotated relative to each other. One advantage is that the friction clutch according to the invention continuously slips, and therefore an improved, uniform readjustment of the air gap is enabled. Moreover, no axial deviating movements of latching elements, as in the case of the known latching clutch, have to be taken into consideration structurally and absorbed.

It is advantageous that the friction element and the counter-friction element are arranged coaxially. The coaxial arrangement corresponds to the coaxial arrangement of the drive wheels. The friction element and the counter-friction element can be disposed in a structurally simple manner and in a compact construction mode in the region of the mutually opposite end faces of the drive wheels. Owing to the pure force-fit generated by the clutch, which is described above, no movable parts whatsoever are required.

In an advantageous embodiment, it can be provided that the friction element and the counter-friction element are conical. The friction element can have a conical section at least partly converging in the axial adjustment direction and having a conical friction surface, which can be designed as an outer cone or inner cone, and which has a corresponding conical section on the counter-friction element, which is correspondingly designed in the opposite direction as an inner cone or outer cone and has a conical counter-friction surface. To produce the engagement of the clutch, the outer cone enters the inner cone, with the conical friction and counter-friction surfaces being loaded frictionally against each other by an axial actuation force of the clutch. One advantage is that the axially acting actuation force of the clutch can be converted by the cone into the normal force acting between the conical friction surfaces during the friction contact. Thus, a relatively small axial actuation force can be converted by a relatively shallow slope into a larger normal force in the friction contact, as a result of which a high clutch torque can already be realized by a relatively small axial actuation force of the clutch.

Alternatively or in addition to the above-mentioned embodiment, it can be provided that the friction element and the counter-friction element are planar. The mutually corresponding friction surfaces are at least partly designed as flat axial surfaces, similar to a disk clutch. A space-saving arrangement is made possible, especially if only a relatively small clutch torque is to be realized.

It can preferably be provided that the friction element and the counter-friction element are preloaded against each other. Preferably, the friction element and the counter-friction element are preloaded against each other elastically or resiliently. The friction and counter-friction surfaces are pressed against each other in the frictional connection by a predetermined axial preload force. In order to generate the preload force, an elastic preload element can preferably be provided, for example, a spring element or the like. The clutch torque of the friction clutch is determined by the actuation force acting perpendicular to the friction contact, i.e. the force applied axially between the friction and counter-friction element, with a greater preload force resulting in a larger clutch torque. This opens up the advantageous possibility of simply predetermining the clutch torque by the preload force exerted by the preload element. For example, in the case of a spring element which is flexible in the axial direction under pressure, such as a compression spring, the preload force exerted can be simply predetermined and adjusted by the spring constant and the compression of the spring.

The aforementioned embodiment can be advantageously implemented in that the friction element and/or the counter-friction element are/is axially displaceable and supported against the first drive wheel or the second drive wheel via an axially effective spring element. The friction element or the counter-friction element are torque-lockingly and axially displaceably connected to the one drive wheel, for example via radially projecting drivers producing a form fit, which is effective in the circumferential direction. The spring element which is axially clamped between the friction element or the counter-friction element and the one drive wheel and is preferably designed as an axially effective compression spring ensures that the friction or counter-friction element is preloaded axially against the corresponding counter-friction or friction element, which is axially supported on the other drive wheel, i.e., is axially pressed against it during the friction contact. The corresponding counter-friction or friction element is connected to the respective other drive wheel for conjoint rotation. It is also possible that, alternatively or additionally, the counter-friction element is supported on one of the drive wheels via a spring element. One advantage of this arrangement is that this friction clutch can be incorporated between the drive wheels in a structurally simple and space-saving manner.

In an advantageous refinement, it is possible that the friction element and/or the counter-friction element are/is arranged in the first drive wheel or the second drive wheel. For example, it is possible to design the drive wheel to be substantially drum-shaped, and therefore the friction or counter-friction element can be arranged in an interior space enclosed by the rotating gearwheel or gear rim. This permits a compact design which is protected against external influences. Thus, for example, the drive wheel of the first actuating drive can have a conical friction element which engages axially in a counter-friction element, which is designed as an inner cone and is at least partly arranged within the second drive wheel.

A particularly compact design can be realized—in particular in the last-mentioned embodiment—in that the drive wheels are arranged within the axial extent of the actuating drives, i.e., are not attached protruding axially on one side.

It is preferred that the friction element and/or the counter-friction element have/has a friction pad. The friction and counter-friction element preferably have a metallic basic body, for example made of steel. In order to avoid metal-to-metal contact, a coating or a pad for producing a friction pairing with a defined friction force can preferably be applied, for example, made of sintered materials, metal and/or ceramic friction materials, composite materials or the like. This can ensure a defined, reproducible clutch torque.

It can be provided that an actuating drive has a spindle drive. In this case, in a manner known per se, a threaded spindle engages in a spindle nut and a relative rotating drive via a drive wheel connected to the threaded spindle or the spindle nut. It is possible for the spindle nut to form the drive-side drive element of the actuating drive, and the threaded spindle the output-side output element, which is linearly adjustable relative thereto, or vice versa.

It is possible for an actuating drive to have a ball ramp arrangement, V-pulley arrangement or a tilting pin arrangement. In the case of a ball ramp arrangement, also referred to as a ramp bearing, the drive and output elements preferably have cam disks with raceways or ramps which are inclined against the axis and between which balls which are rollable in the circumferential direction are arranged. Owing to the balls rolling on the ramps, a relative rotation causes the output element to be axially displaced relative to the drive element. In a tilting pin arrangement which is known per se, tilting pins are arranged between the drive element and output element and are each supported in the circumferential direction in such a way that, in the event of a relative rotation, they are inclined to a greater or lesser extent against the axis depending on the direction of rotation, as a result of which the distance between the drive element and output element is also adjustable.

In the actuating device, two identically acting actuating drives can be combined with each other as first and second actuating drives, for example, two spindle drives. It is also possible to combine two different designs together, for example, a ball ramp arrangement as the first actuating drive, and a spindle drive as the second actuating drive, for adjusting the air gap. The respective characteristic properties of each design can be optimally exploited. For example, a non-linear adjustment characteristic and/or at least partially self-locking properties, and/or a defined dead center or extended position, which permits a defined adjustment path, can be realized with little outlay using a ball ramp arrangement. The implementation of the aforementioned positive properties may at least partially require a precise specification of the air gap, which can be implemented without any problems using the friction clutch according to the invention.

A braking device according to the invention can comprise an actuating device and a brake part which is connected thereto, is adjustable along an axis by the actuating device and can be brought into braking engagement with a counter-brake part, wherein the actuating device has a first actuating drive and a second actuating drive, which is coupled in series thereto, wherein the first actuating drive has a rotationally driveable first drive wheel, and the second actuating drive has a rotationally driveable second drive wheel which is coaxial with the first drive wheel, wherein a clutch device is arranged between the first drive wheel and the second drive wheel.

The actuating device is driveable by at least one electric actuating motor. The latter preferably meshes with at least one drive wheel. Preferably, one actuating motor can in each case be provided for the first and second drive wheel. According to the invention, the actuating motor or the actuating motors are activatable by a wheel brake control unit assigned to the braking device.

In the latter embodiment of the braking device, it may preferably be provided that the clutch device is configured as a friction clutch having a friction element which, during engagement of the clutch, is connectable in a friction-fitting manner to a counter-friction element.

This makes it possible to implement the advantages explained above in the context of the braking system.

In order to implement the method according to the invention, it can be provided that the braking device has an actuating device which is able to be coupled to an actuating motor and comprises a first actuating drive and a second actuating drive coupled in series thereto, and which acts on a brake part that in the direction of an axis can be brought into braking engagement with a counter-braking part, wherein the first actuating drive has a rotationally driveable first drive wheel to which a first drive torque can be applied for the actuation, and the second actuating drive has a rotationally driveable second drive wheel which is coaxial with the first drive wheel and to which a second drive torque can be applied for the actuation, wherein a clutch device is arranged between the first drive wheel and the second drive wheel, wherein it is provided according to the invention that the clutch device is configured as a friction clutch and has a predefinable clutch torque which, when exceeded, causes the first drive wheel to slip relative to the second drive wheel, wherein, for actuation of the first actuating drive, the first drive wheel and the second drive wheel are driven synchronously so that the second actuating drive remains non-actuated, and, for actuation of the second actuating drive, the second drive wheel is driven and the first drive wheel is stopped relative thereto, so that the friction clutch slips and the first actuating drive remains non-actuated.

The features mentioned above in conjunction with the braking device according to the invention can be used individually and in combinations for implementing the method according to the invention.

For adjusting the first actuating drive, an actuating torque can be coupled into the first drive wheel by means of a first electric actuating motor and, accordingly, the second actuating drive can be driven by a second electric actuating motor.

During the normal braking mode, the first and second drive wheels are rotated synchronously. This can take place, on the one hand, by the first and second drive wheels being driven by the first and second actuating motors with synchronized driving torques. On the other hand, the second drive wheel can be entrained synchronously by the clutch device during driving of the first drive wheel, as long as the transmitted driving torque remains under the clutch torque. In this operating mode, the second actuating drive remains non-actuated and idly revolves as a whole together with the brake element.

In the method, when the clutch torque is exceeded, in order to adjust the air gap, the clutch device can slip continuously and uniformly. This can be implemented, for example, in that the drive wheel of the first actuating drive is stopped, for example by a brake or a corresponding activation of the first drive motor, while a second driving torque, which is greater than the clutch torque, is applied to the second drive wheel by the second drive motor. Thus, the second drive wheel is rotated relative to the first drive wheel and, by actuation of the second actuating drive, the air gap can be continuously and finely adjusted such that continually progressive wear on the brake element or the brake pad can be optimally compensated.

It is possible for the first drive wheel and the second drive wheel to be torque-lockingly coupled by the friction clutch in order to produce a synchronous drive.

In this case, synchronous driving of the two drive wheels by the actuating motors is not required. Any torque differences can be compensated within predetermined tolerances.

It can be advantageously provided that a higher clutch torque is specified when the first actuating drive is actuated than when the second actuating drive is actuated. The first actuating drive is actuated by synchronous driving of the first and second drive wheels. The friction element and the counter-friction element are preloaded against each other by the spring force of the spring element, and in addition, the adjustment force of the first actuating drive acts in opposition to the spring force. This results in a relatively high clutch torque. If, on the other hand, only the second drive wheel is rotated to adjust the air gap, the spring force alone is in action, and therefore a lower clutch torque is set. This facilitates the adjustment of the air gap.

### DESCRIPTION OF THE DRAWINGS

Advantageous embodiments of the invention will be described in more detail below with reference to the drawings, specifically:

FIG. 1 shows a schematic perspective view of a braking device according to the invention,

FIG. 2 shows a lateral view of the braking device according to FIG. 1,

FIG. 3 shows a detached schematic perspective view of the actuating device according to the invention of the braking device according to FIG. 1,

FIG. 4 shows a section Q-Q through the braking device according to FIG. 1,

FIG. 5 shows a detached schematic perspective illustration of the first actuating drive of the braking device according to FIG. 1,

FIG. 6 shows an enlarged detailed view of the actuating device from FIG. 4,

FIG. 7 shows a longitudinal section through a motor mounted on the drive carrier of the brake device,

FIG. 8 shows a cross section through a motor according to the invention according to FIG. 7,

FIG. 9 shows an enlarged cross section through the rotor of the motor according to FIG. 8,

FIGS. 10a,b,c show cross sections through different designs of a rotor magnet of the motor according to FIG. 8 or 9.

### EMBODIMENTS OF THE INVENTION

In the various figures, identical parts are always provided with the same reference signs, and will therefore generally also be named or mentioned only once in each case.

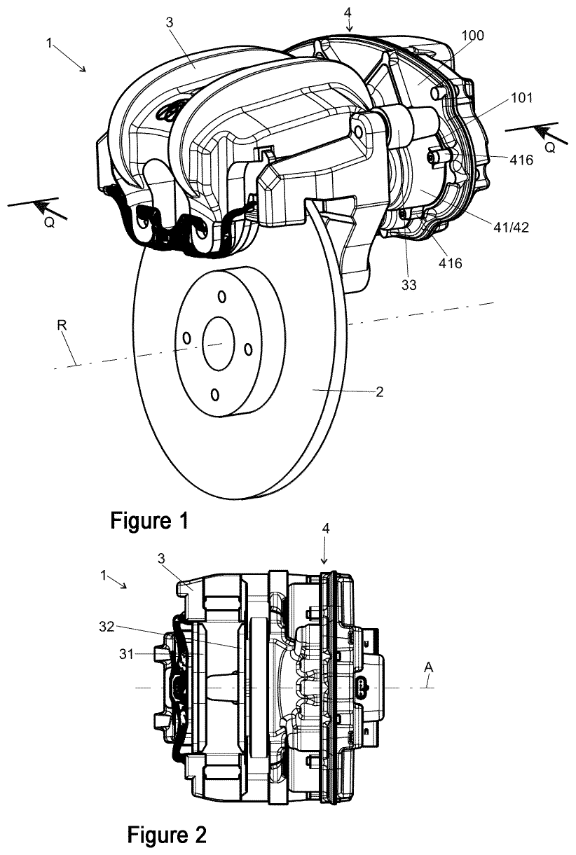

FIG. 1 shows a braking device according to the invention as a whole, in the form of a disk brake. This braking device comprises a brake disk 2, which forms a counter-brake part and is connected to a vehicle wheel which is rotatable about a wheel axis R and is not illustrated here. A brake caliper 3 engages about the two axial end faces of the brake disk 2.

The brake disk 2 is designed here as an unventilated brake disk made of solid material. Alternatively, it can also be designed as an internally ventilated brake disk.

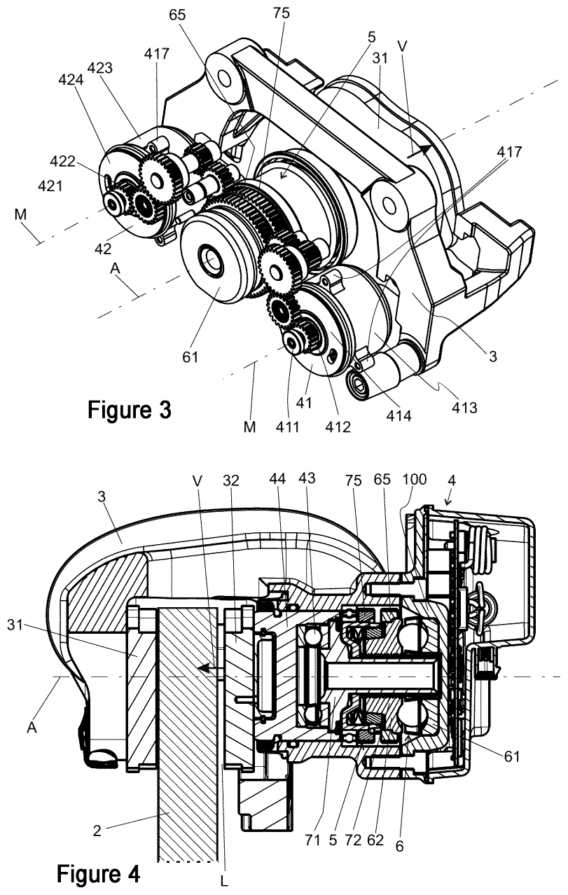

An electric brake actuator 4 according to the invention, which is shown in FIG. 3 in a separate, detached schematic perspective view, and is explained in detail in FIGS. 4 to 6, is attached to the brake caliper 3.

The brake actuator 4 comprises an actuating device 5 which extends axially in the direction of an axis A that lies parallel to the wheel axis R and indicates the adjustment direction V of the actuating device 5.

As can be seen in the sectional illustration of FIG. 4 along the axis A, the brake disk 2 is arranged axially between two brake pads 31 and 32. The one brake pad 31 is fixedly supported on the brake caliper 3 on the side facing away from the brake actuator 4. The other brake pad 32, which forms a brake part within the meaning of the invention, is attached to the actuating device 5 and is adjustable by the latter in the axial adjustment direction V, indicated by the axis A, toward the brake disk 2 to produce the braking engagement, as indicated in FIG. 4 by the arrow.

In the unactuated state of the braking device 1, an axial air gap L, which is shown schematically with an exaggerated width in FIG. 4, is located between the brake disk 2 and the adjustable brake pad 32.

The design of the actuating device 5 is illustrated in FIG. 4 and in the enlarged detail thereof in FIG. 6.

The actuating device 5 comprises a first actuating drive 6, which has a ball ramp arrangement, also referred to as a ramp bearing, and a second actuating drive 7, which is coupled axially thereto in series (with respect to the axis A) and has a spindle drive.

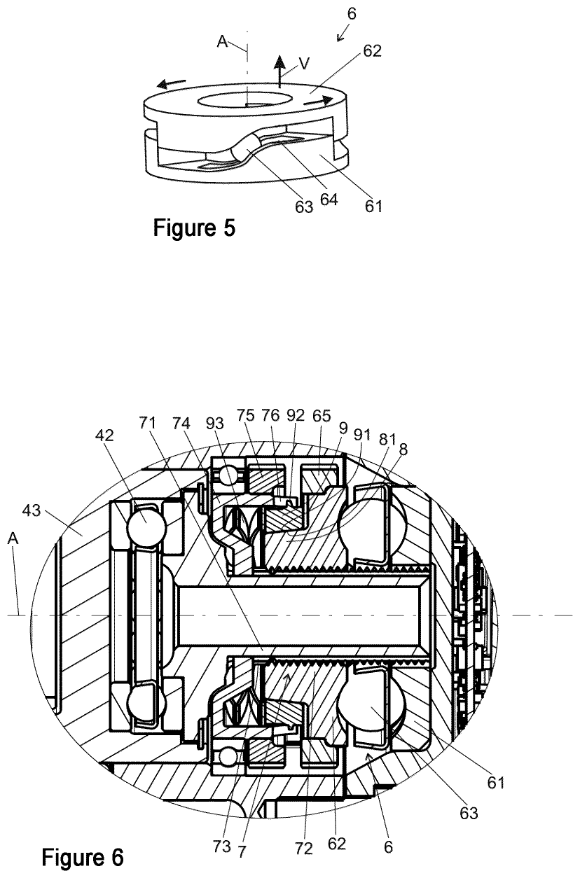

The first actuating drive 6, which is formed in the example shown as a ball ramp arrangement or ramp bearing, comprises a drive-side cam disk 61, which is supported axially on the brake actuator 4 for rotation therewith, and an output-side cam disk 62. Balls 63 are arranged between the cam disks 61 and 62. As can be seen in the schematically detached view of FIG. 5, the cam disks 61 and 62 have mutually axially opposite ramp-like raceways 64, which lie obliquely with respect to the axis A and between which balls 63 can roll. Rotation of the output-side cam disk 62, at the top in FIG. 5, relative to the fixed drive-side cam disk 61—as schematically indicated by the curved arrows—leads to a linear adjustment of the output-side cam disk 62 in the adjustment direction V parallel to the axis A. Thus, as shown in FIG. 4, the brake pad 32 can be brought into braking engagement by actuation of the first actuating drive 6.

The cam disk 62 is connected to a coaxial gearwheel 65, which is in the form of a spur gear and forms a drive wheel in the context of the invention.

The gearwheel 65 meshes with a first electric actuating motor 41, which is synonymously also referred to as a motor 41 for short. This enables the rotating drive of the cam disk 62 and thus actuation of the first actuating drive 6.

The second actuating drive 7, which in the example shown is in the form of a spindle drive, has, on the output side, a threaded spindle 71, which engages in the internal thread of a drive-side spindle nut 72. This internal thread is formed in the output-side cam disk 62 of the first actuating drive 6 such that the functions of the output-side cam disk 62 and the drive-side spindle nut 72 are combined in one component.

The threaded spindle 71 is connected via a hub part 74 to a coaxial gearwheel 75, which is rotatably mounted in axially fixed form in the brake actuator 4. The threaded spindle is torque-lockingly but axially displaceably coupled to the gearwheel 75 via drivers 73, which can have, for example, radially projecting projections or teeth, which engage axially movably in axial slots of the hub part 74.

The gearwheel 75, like the gearwheel 65, can be designed as a spur gear and is arranged coaxially adjacent to the latter. Said gearwheel 75 meshes with a second electric actuating motor 42, which is synonymously also referred to as a motor 42 for short. This enables the rotating drive of the threaded spindle 71 and thus actuation of the second actuating drive 7.

The threaded spindle 71 is axially connected via a thrust bearing 43, for example, as shown, an axial rolling bearing, to a thrust member 44 to which the displaceable brake pad 32 is attached, as can be seen in FIG. 4. The thrust member 44 may also be referred to as a piston.

The clutch device has a friction element 8, which, as a coaxial, conical shoulder, is directed from the cam disk 62 to the second actuating drive 7. The conical shoulder has a conical friction surface 81 disposed on the outside of an outer cone. The friction element 81 can preferably be formed integrally with the cam disk 62/spindle nut 72.

When the clutch is engaged, the friction element 8 is frictionally coupled to a counter-friction element 9. In this case, the conical shoulder axially enters a corresponding conical opening in the counter-friction element 9, which has a conical friction surface 91 arranged in an inner cone. When the clutch is engaged, the friction surface 81 and the counter-friction surface 91 lie frictionally against each other, as can be clearly seen in FIG. 6.

The counter-friction element 9 is torque-lockingly but axially displaceably coupled to the gearwheel 75 via drivers 92, which engage in corresponding slots 76 in the hub part 74 or in the gearwheel 75.

A spring element 93 is disposed between the gearwheel 75, or the hub part 74, connected thereto, and the counter-friction element 9. Owing to its axially effective spring force, the counter-friction element 9 is elastically clamped against the friction element 8. A defined clutch torque of the friction clutch according to the invention formed by the friction element 8 and the counter-friction element 9 is produced as a result.

FIG. 3 shows how the two motors 41, 42 and the actuating device 5 are arranged relative to the brake caliper 3. In this illustration, the drive carrier 100 is omitted for better clarity.

Each of the motors 41, 42 has a motor shaft 411, 421 which is rotationally driveable about a motor axis M and lies parallel to the axis A. On each of said motor shafts is mounted a gearwheel 412 or 422, which in each case meshes with the gearwheel 65 or 75 of the actuating device 5.

Each motor 41, 42 has a motor housing 413, 423 which, in the example shown, has a cylindrical basic shape. It is in the shape of a cup and closed on its axial end face facing the viewer in FIG. 3 in each case by means of a bearing cover 414, 424, wherein the motor shaft 411, 412 bearing a rotor of the motor 41 is in each case mounted in the bearing cover 414, 424 and protrudes axially therefrom.

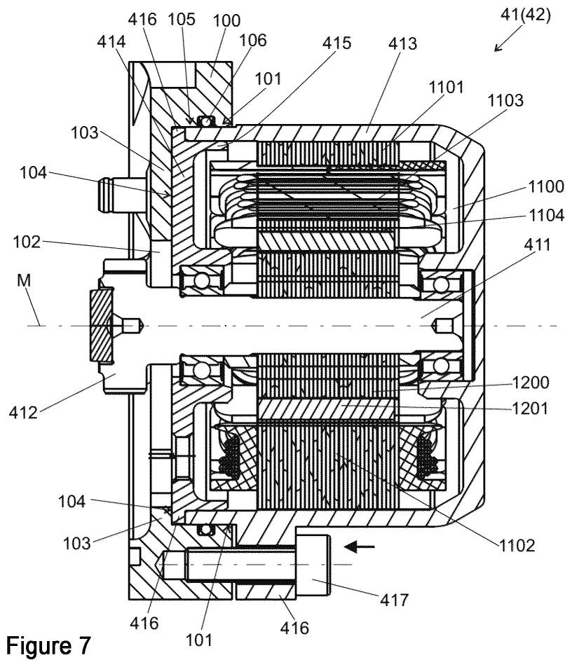

FIG. 7 shows a longitudinal section along the motor axis M through the motor 41 or 42, wherein, for better clarity, only the reference signs for the motor 41 that are correspondingly, however, also present in the other motor 42 are provided.

The drive carrier 100 has a recess 101, which comprises an opening 102 passing through the drive carrier 100. A projection 103 projecting in a stepped manner radially inward into the opening cross section has an axial support surface 104 which is directed against the motor 41. The recess 101 is delimited radially outward by a circumferential inner surface 105 coaxial to the motor axis M.

The inner surface 105 is adapted to the outer diameter of the motor housing 413 in such a way that the latter is insertable axially therein and is held and supported radially in a form-fitting manner, i.e., transversely to the motor axis M.

The bearing cover 414 is inserted with an axial shoulder 415 axially from the front into the motor housing 413. With its front end face—which, by definition, faces the front and, in FIG. 7, to the left—the bearing cover 414 bears axially against the support surface 104 of the recess 101.

The bearing cover 414 furthermore has a circumferential, radially projecting collar 416, which is arranged axially between the motor housing 413 and the support surface 104.

The motor housing 413 has flange elements 416 projecting radially outward over the recess 101 and having axially continuous flange bores, through which screws 417 serving as fastening elements are guided and screwed into corresponding threaded bores in the drive carrier 100.

By screwing in and tightening the screws 417, the motor housing 413 is secured on the drive carrier 100 and clamped therewith. The bearing cover 414 together with the motor housing 413 is axially clamped against the support surface 104 (to the left in FIG. 7 as indicated by the arrow), and at the same time axially pressed into the motor housing 413 (to the right in FIG. 7) and fixed. Thus, the screws 417 have a dual function for securing the motor 41 on the drive carrier 100 and for connecting the bearing cover 414 to the motor housing 413. The support surface 104 and the inner surface 105 provide a defined alignment of the motor 41 relative to the drive carrier 100.

Between the motor housing 413 and the inner surface 105, an O-ring 106 made of an elastic elastomer or rubber material can furthermore be arranged, for example, as shown in a groove encircling the inside of the inner surface 105. Said O-ring is elastically clamped there in the radial direction and ensures that the motor housing 413 is held frictionally in the recess 101 by simple axial insertion—to the left in the direction of the arrow in FIG. 7. In addition, the motor 41 can therefore be sealed against the drive carrier 100.

The bearing cover 414 has a receiving opening 418 through which the motor shaft 411 extends, wherein, between the motor shaft 411 and the receiving opening 418, a bearing 419 for the rotatable mounting of the motor shaft 411 is arranged opposite the bearing cover 414, said bearing being in the form of a rolling bearing, more precisely a radial deep groove ball bearing. The receiving opening 418 has an inwardly projecting shoulder portion 418a, against which the bearing 419 lies in the direction of the motor axis M and is supported on the latter.

The motor 41 shown in FIG. 7 has a stator 1100 which is fixedly arranged in the motor housing 413 and has a laminated core by which a radially outwardly encircling, substantially hollow-cylindrical stator body 1101 is formed, from which a plurality of stator teeth 1102 radially project inward. Stator windings 1103 are arranged from the stator teeth 1102.

A rotor 1200 is attached to the motor shaft 411 for conjoint rotation. Said rotor has a total of 10 (ten) rotor magnets 1201 uniformly mounted over the circumference. Correspondingly, the number of poles is 10 (ten).

Between the outer circumference of the rotor 1200 and the inner circumference of the stator 1100, a circumferential air gap 1104 is formed.

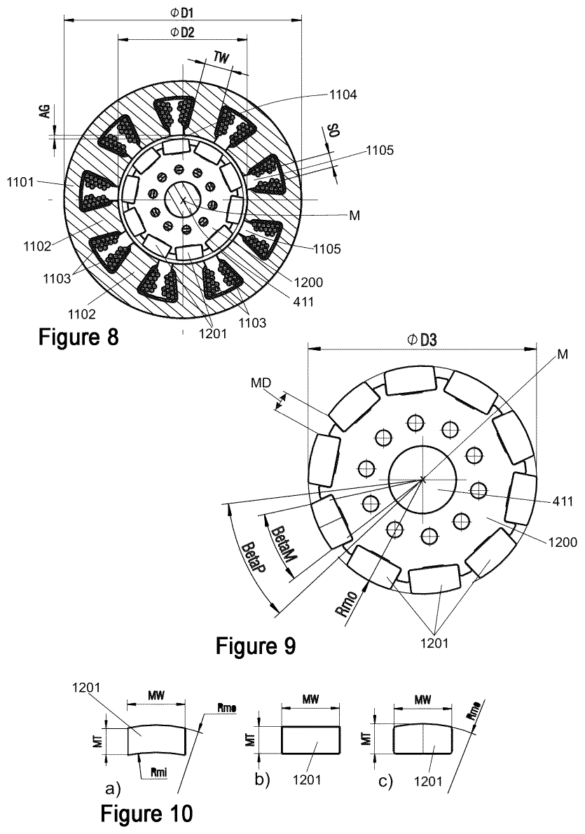

FIG. 8 shows a cross section through the stator 1100 and the rotor 1200 of the motor 41.

The stator 1100 has a stator outer diameter D1 and a stator inner diameter D2.

In the example shown, the stator 1100 has 9 (nine) stator teeth 1102. The latter extend from the rotor body 1101 radially inward as far as the rotor inner diameter D2. On the outside of the rotor body 1102, the rotor teeth 1102 each have a tooth width TW measured in the circumferential direction. On the inside in the region of the rotor inner diameter D2, a stator gap 1105 is in each case formed between adjacent stator teeth 1102, the stator gap having a gap width SO measured in the circumferential direction.

The rotor 1200 has a rotor diameter D3, to which the rotor magnets 1201 are adjacent from the inside.

The difference between the stator inner diameter D2 and the rotor diameter D3 results in the air gap width AG=D2−D3 of the air gap 1104.

FIG. 9 shows an enlarged view of the rotor 1200 from FIG. 8.

The rotor magnets 1201 are uniformly offset by a pole angle BetaP which, in the example with the 10 (ten) rotor magnets 1201, has a value of 360°/10=36°.

With respect to the motor axis M, the rotor magnets 1201 extend on the rotor diameter D3 over a magnetic angle BetaM. The difference between the angles BetaP-BetaM determines the magnet distance MD measured on the rotor diameter D3 in the circumferential direction.

FIGS. 10a, b, c show alternative cross sections according to the invention of an individual rotor magnet 1201 in the view of FIG. 8.

According to FIG. 10b, the cross section is rectangular with flat sides, the magnet width being MW and the magnet thickness MT. These are in the ratio according to the invention to each other.

The embodiment according to FIG. 10c has a flat inner side—at the bottom in the drawing—and a cylindrical outer side, which is rounded with respect to the motor axis M with a radius Rmo, which corresponds to half the rotor diameter D3, as can be seen in FIG. 9. The magnet width MW corresponds to the dimension of the flat inner side in the circumferential direction, and the magnet thickness MT is measured perpendicular to said inner side.

The embodiment according to FIG. 10a, like the embodiment according to FIG. 10c, has a cylindrical outer side with a radius Rmo. In addition, the inner side is cylindrically rounded coaxially with respect to the outer side with a correspondingly smaller inner radius Rmi. The side surfaces lie parallel to each other and to a diameter and extend radially over the magnet thickness MT such that the smaller inner radius Rmi approximately corresponds to the radius Rmo minus the magnet thickness MT.

### LIST OF REFERENCE SIGNS

1 Braking device
100 Drive carrier
101 Recess
102 Opening
103 Projection
104 Support surface
105 Inner surface
106 O-ring
1100 Stator
1101 Stator body
1102 Stator tooth
1103 Stator winding
1104 Air gap
1105 Stator gap
1200 Rotor
1201 Rotor magnet
2 Brake disk
3 Brake caliper
31, 32 Brake pad
33 Fastening bolt
4 Brake actuator
41, 42 Motor (actuating motor)
411, 421 Motor shaft
412, 422 Gearwheel
413, 423 Motor housing
414, 424 Bearing cover
415, 425 Shoulder
416, 426 Flange element
417, 427 Screw
418 Receiving opening
418a Shoulder section
419 Bearing
43 Thrust bearing
44 Thrust member
5 Actuating device
6 First actuating drive
61 Cam disk
62 Cam disk (integrated with spindle nut 72)
63 Ball
64 Raceway
65 Gearwheel
66 Ball cage
67 Depression
7 Second actuating drive
71 Threaded spindle
72 Spindle nut (integrated with cam disk 62)
73 Driver
74 Hub part
75 Gearwheel
76 Slot
8 Friction element
81 Friction surface
9 Counter-friction element
91 Counter-friction surface
92 Driver
93 Spring element
A Axis
R Wheel axis
V Adjustment direction
L Air gap
M Motor axis
D1 Stator outer diameter
D2 Stator inner diameter
D3 Rotor diameter
TW Tooth width
AG Air gap width
SO Gap width
BetaP Pole angle
BetaM Magnetic angle
MW Magnet width
MT Magnet thickness
MD Magnet distance

1-12. (canceled)

13. An electromechanical braking device for a motor vehicle, comprising:
an actuating device which is driveable by at least one electric motor and by which a brake part is adjustable;
wherein the motor has a stator and a rotor, which is rotatably mounted therein about a motor axis;
wherein the stator has a stator outer diameter and a stator inner diameter and comprises a number of radially inwardly projecting stator teeth which are distributed over the circumference, have a tooth width in the circumferential direction on the stator outer diameter and between which a stator gap having a gap width is in each case located on the stator inner diameter, and which support at least one stator winding;
wherein the rotor comprises a rotor diameter and a number of poles, which deviate from the number of stator teeth, of rotor magnets which are distributed over the outer circumference, are in the form of permanent magnets and extend in a rod-shaped manner axially parallel to the rotor axis, and which each have a radial magnet thickness and a magnet width in the circumferential direction, and the rotor magnets are each spaced apart at a magnet distance on the rotor diameter;
wherein a radial air gap having a radial air gap width is formed between the stator teeth and the rotor magnets;
wherein the ratio of the magnet thickness to the magnet width is between 0.4 and 0.55.

14. The braking device as claimed in claim 13, wherein the rotor magnets have a rectangular cross section.

15. The braking device as claimed in claim 13, wherein the rotor magnets have a cross section in the shape of a hollow cylinder segment.

16. The braking device as claimed in claim 13, wherein the rotor magnets have a segment-like cross section with a cylindrical outer surface and a flat inner surface.

17. The braking device as claimed in claim 13, wherein a rotor magnet extends on the rotor diameter with respect to the motor axis over a magnetic angle section, and the rotor magnets are offset relative to one another by a pole angle, the ratio of the magnetic angle section to the pole angle being between 0.65 and 0.75.

18. The braking device as claimed in claim 13, wherein the number of poles is 8 or 10.

19. The braking device as claimed in claim 13, wherein the number of stator teeth is 6 or 9.

20. The braking device as claimed in claim 13, wherein the ratio of the air gap width to the tooth width is between 0.45 and 0.65.

21. The braking device as claimed in claim 20, wherein the ratio of the air gap width to the tooth width is between 0.5 and 0.6.

22. The braking device as claimed in claim 13, wherein the ratio between the stator outer diameter and the stator inner diameter is between 0.55 and 0.65.

23. The braking device as claimed in claim 13, wherein the ratio between the air gap width and the stator inner diameter is between 0.015 and 0.03.

24. The braking device as claimed in claim 13, wherein the braking device has at least two motors.
